(19) United States
(12) Patent Application Publication
(10) Pub. No.: US 2025/0282208 A1
(43) Pub. Date: Sep. 11, 2025

(54) POWER UNIT MOUNTING STRUCTURE

(71) Applicant: TOYOTA JIDOSHA KABUSHIKI KAISHA, Toyota-shi (JP)

(72) Inventor: Ryo UMEOKA, Nisshin-shi (JP)

(73) Assignee: TOYOTA JIDOSHA KABUSHIKI KAISHA, Toyota-shi (JP)

(21) Appl. No.: 18/979,174

(22) Filed: Dec. 12, 2024

(30) Foreign Application Priority Data
Mar. 11, 2024 (JP) 2024-037636

(51) Int. Cl. B60K 1/00; B60K 17/04

(52) U.S. Cl. CPC B60K 1/00; B60K 17/04

(57) ABSTRACT

The power unit mounting structure includes: a power unit mounted in a power unit room and disposed opposite to a dash panel separating a power unit room and a vehicle cabin in a vehicle front-rear direction; and an energization portion provided on one side surface of the power unit in the vehicle width direction, wherein the power unit is provided such that the other part in the vehicle width direction is closer to the dash panel than the one part in the vehicle width direction on the side surface facing the dash panel.

### CROSS-REFERENCE TO RELATED APPLICATION

This application claims priority to Japanese Patent Application No. 2024-037636 filed on Mar. 11, 2024, incorporated herein by reference in its entirety.

### BACKGROUND

### 1. Technical Field

The present disclosure relates to a power unit mounting structure.

### 2. Description of Related Art

Hitherto, power units including motors as drive sources that generate power during traveling each require protection of an energization portion of the power unit from damage caused by collision.

Japanese Unexamined Patent Application Publication No. 2021-030802 (JP 2021-030802 A) describes a powertrain structure that electrically connects a motor and an inverter provided above the motor in the inside of a motor case. In this powertrain structure, an opening accessible to an electrical connection portion between the motor and the inverter is provided on a rear surface of the motor case provided to face an electric compressor. A cover member that closes the opening is provided with a protrusion that receives a collision load when the motor and the electric compressor collide with each other. Accordingly, the electrical connection portion between the motor and the inverter disposed above the motor is protected at the time of vehicle front collision.

### SUMMARY

When the energization portion is disposed in a vehicle front-rear direction as in JP 2021-030802 A, it is likely that the energization portion is susceptible to the collision load at the time of front collision or rear collision. Therefore, a dead space is likely to be generated in a power unit room in order to secure a space for protecting the energization portion. When the protrusion is provided in the vicinity of the energization portion for protection as in JP 2021-030802 A, the size of the protrusion may increase and the weight of the power unit may increase.

Therefore, an object of the present disclosure is to provide a power unit mounting structure capable of reducing a dead space in a power unit room of a vehicle and a weight of a power unit, and suppressing damage to an energization portion provided in the power unit at the time of front collision or rear collision.

A power unit mounting structure according to an aspect of the present disclosure includes a power unit mounted in a power unit room of a vehicle and disposed to face, in a vehicle front-rear direction, a vehicle cabin partition wall that separates the power unit room and a vehicle cabin, and an energization portion provided on one side surface of the power unit in a vehicle width direction.

The power unit is provided, on a side surface facing the vehicle cabin partition wall, closer to the vehicle cabin partition wall at another portion in the vehicle width direction than one portion in the vehicle width direction.

In the power unit mounting structure according to the above aspect of the present disclosure, the energization portion is provided on one side surface of the power unit in the vehicle width direction. That is, the energization portion is not disposed in the vehicle front-rear direction. Therefore, the energization portion is less susceptible to the collision load at the time of front collision or rear collision. Accordingly, it is possible to reduce a space in the vehicle front-rear direction that is necessary for protecting the energization portion, and to reduce a dead space in the power unit room.

The power unit is disposed to face, in the vehicle front-rear direction, the vehicle cabin partition wall that separates the power unit room and the vehicle cabin. The power unit is provided, on the side surface facing the vehicle cabin partition wall, closer to the vehicle cabin partition wall at the other portion in the vehicle width direction than the one portion in the vehicle width direction.

At the time of front collision or rear collision of the vehicle, a collision load from the outside in the vehicle front-rear direction is input into the power unit room to move the power unit inward in the vehicle front-rear direction. Therefore, on the inner side surface of the power unit in the vehicle front-rear direction, the other portion in the vehicle width direction comes into contact with the vehicle cabin partition wall earlier than the one portion in the vehicle width direction.

Consideration is given about a collision load input from the outside in the vehicle front-rear direction to the one portion of the power unit in the vehicle width direction, that is, a portion in the vicinity of the energization portion. The collision load is input while the one portion in the vehicle width direction, such as a bumper reinforcement or a side member, is buckled inward in the vehicle width direction. Therefore, the collision load is transmitted from the one portion of the power unit in the vehicle width direction to the inner side in the vehicle front-rear direction and the other side in the vehicle width direction. Accordingly, the collision load input to the one portion of the power unit in the vehicle width direction, that is, the portion in the vicinity of the energization portion, is transmitted to the vehicle cabin partition wall via the other portion of the power unit in the vehicle width direction. By dispersing the collision load input to the vicinity of the energization portion to the vehicle body side as described above, it is possible to suppress damage to the energization portion. In this structure, it is not necessary to provide both the one portion and the other portion in the vehicle width direction close to the vehicle cabin partition wall in the region where the power unit faces the vehicle cabin partition wall. The energization portion is provided at a portion of the power unit that is different from the region facing the vehicle cabin partition wall. Therefore, the size can be reduced by reducing the number of structures provided for bringing the power unit and the vehicle cabin partition wall closer to each other. Thus, the weight of the power unit can be reduced.

In the power unit mounting structure according to the above aspect of the present disclosure,

the power unit may include a protruding portion provided at least at the other portion in the vehicle width direction in a region facing the vehicle cabin partition wall, and the protruding portion may protrude inward in the vehicle front-rear direction beyond the one portion in the vehicle width direction.

In the power unit mounting structure according to the above aspect of the present disclosure, the collision load input to the vicinity of the energization portion is transmitted to the vehicle cabin partition wall via the protruding portion formed on the power unit. The transmission path of the load can be stabilized by transmitting the collision load via the protruding portion in this way. The shape etc. of the protruding portion can be changed easily. Therefore, it is possible to perform optimization according to the vehicle type without changing the structure of the main portion of the power unit.

In the power unit mounting structure according to the above aspect of the present disclosure,
the power unit may include:
a motor electrically connected to the energization portion;
a gear portion configured to transmit rotation of the motor to a drive wheel; and
a power unit case that houses the motor and the gear portion.
   The motor may be housed on one side in the vehicle width direction in the power unit case. The gear portion may be housed on another side in the vehicle width direction in the power unit case.

In the power unit mounting structure according to the above aspect of the present disclosure, the motor electrically connected to the energization portion is housed on the one side in the vehicle width direction in the power unit case. The gear portion that transmits the rotation of the motor to the drive wheel is housed on the other side in the vehicle width direction in the power unit case. Therefore, when the collision load is input to the other portion of the power unit in the vehicle width direction, that is, when the collision load is input to a portion away from the energization portion, the collision load can be received by the gear portion having a higher load bearing capacity than the motor. Accordingly, the damage to the energization portion can be suppressed even when the collision load is input to the other side of the power unit in the vehicle width direction.

In the power unit mounting structure according to the above aspect of the present disclosure,

the power unit case may include a partition wall that separates a housing space for the motor and a housing space for the gear portion.

In the power unit mounting structure according to the above aspect of the present disclosure, the housing space for the motor and the housing space for the gear portion are separated by the partition wall in the power unit case. Therefore, the structure is such that, for example, even when the collision load is input to the other portion of the power unit in the vehicle width direction and the gear portion is damaged, the damage to the gear portion is unlikely to affect the energization portion. Thus, it is possible to effectively suppress the damage to the energization portion.

In the power unit mounting structure according to the above aspect of the present disclosure, the vehicle cabin partition wall may be a dash panel that separates the power unit room and the vehicle cabin.

In the power unit mounting structure according to the above aspect of the present disclosure, the collision load input to the vicinity of the energization portion provided in the power unit is transmitted to the dash panel. Therefore, the damage to the energization portion at the time of front collision or rear collision can be suppressed while reducing a dead space generated between the power unit and the dash panel and the weight of the power unit in the power unit room.

As described above, according to the present disclosure, it is possible to reduce the dead space in the power unit room of the vehicle and the weight of the power unit, and suppress the damage to the energization portion provided in the power unit at the time of front collision or rear collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view schematically showing a power unit mounting structure according to the present embodiment;

FIG. 2 is an enlarged schematic plan view of the power unit mounting structure according to the present embodiment;

FIG. 3 is a schematic perspective view illustrating a power unit according to the present embodiment, partially cut away, as viewed from a left obliquely rear side of the vehicle; and

FIG. 4 is a schematic plan view illustrating an enlarged state in which a barrier collides with a power unit mounting structure according to the present embodiment from a vehicle front side.

### DETAILED DESCRIPTION OF EMBODIMENTS

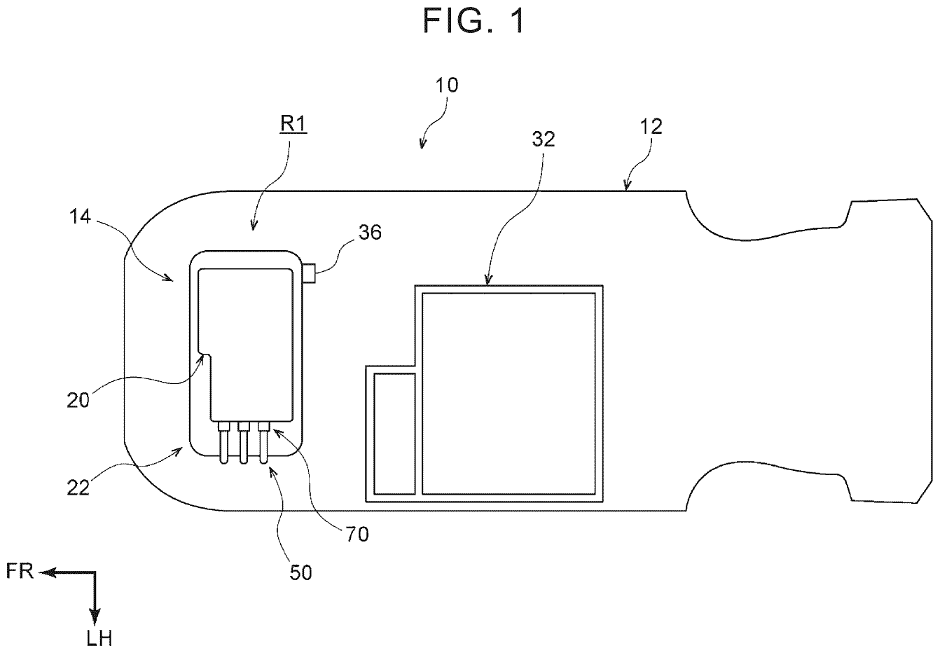

Hereinafter, an embodiment according to the present disclosure will be described with reference to FIGS. 1 to 4. For convenience of explanation, an arrow UP shown in the drawings is defined as a vehicle upward direction, an arrow FR is defined as a vehicle forward direction, and an arrow LH is defined as a vehicle leftward direction. Thus, when terms indicating directions, i.e., upward and downward, forward and rearward, and right and left are used in the following description without any specification, these mean upward and downward of the vehicle, forward and rearward of the vehicle, and right and left of the vehicle. Further, the right-left direction is synonymous with a vehicle width direction.

### Overall Configuration of Power Unit Room

As illustrated in FIGS. 1 to 4, the power unit mounting structure 10 according to the present embodiment is mounted on the front portion of the vehicle 12 as an example. A power unit room R1 is provided at a front portion of the vehicle 12, and a power unit 14 as a group of devices for generating power during traveling of the vehicle 12 is mounted. In the power unit mounting structure 10 mounted on the front portion of the vehicle, the “vehicle front-rear direction outer side” is the vehicle front side, and the “vehicle front-rear direction inner side” is the vehicle rear side.

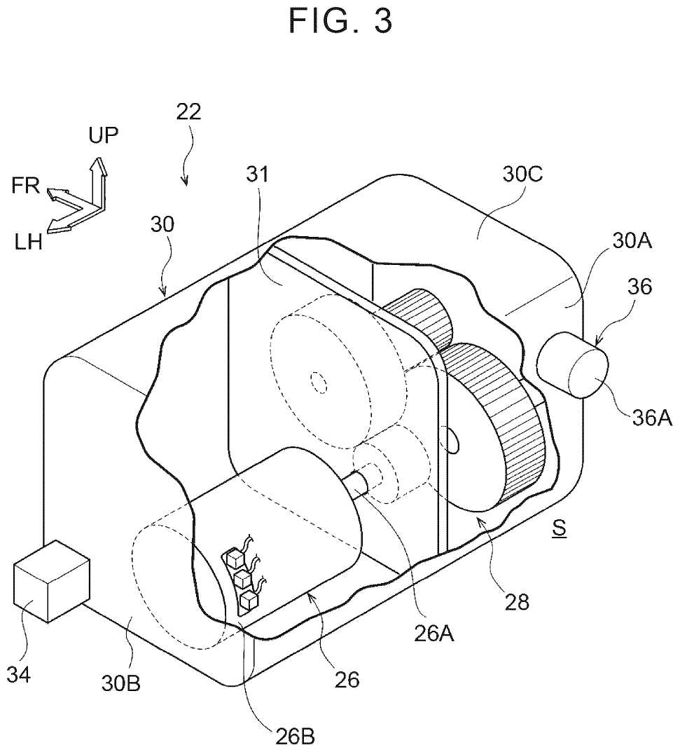

In one embodiment, the vehicle 12 is a battery electric vehicle (EV vehicle) that can be charged. For this reason, the power unit 14 includes a transaxle 22 that generates power during traveling, and an inverter 20 provided at an upper portion of the transaxle 22. The transaxle 22 includes, for example, a motor 26 as a drive source and a gear portion 28 that supplies the rotation of the motor 26 to the drive wheels (see FIG. 3). The motor 26 and the gear portion 28 are housed in the power unit case 30 that constitutes the outer shell of the transaxle 22. The inverter 20 is configured to control the electric power supplied to the motor 26 by converting the direct current flowing from the battery 32 into an alternating current (three-phase alternating current). The inverter 20 is electrically connected to the motor 26 housed in the power unit case 30 via an energization portion 50 described later. Therefore, in the power unit 14, the motor 26, the gear portion 28, and the inverter 20 are integrated to form one unit.

As shown in FIG. 1, a battery 32 charged via a charger (not shown) is mounted at a substantially central portion of the vehicle 12 in the front-rear direction. Although not shown, in the battery 32, the front end of the charging cable extending from the charger is routed to a charging port (not shown) for external power connection provided on the outer plate of the vehicle 12. Accordingly, the battery 32 can be charged by the electric power of the external power source.

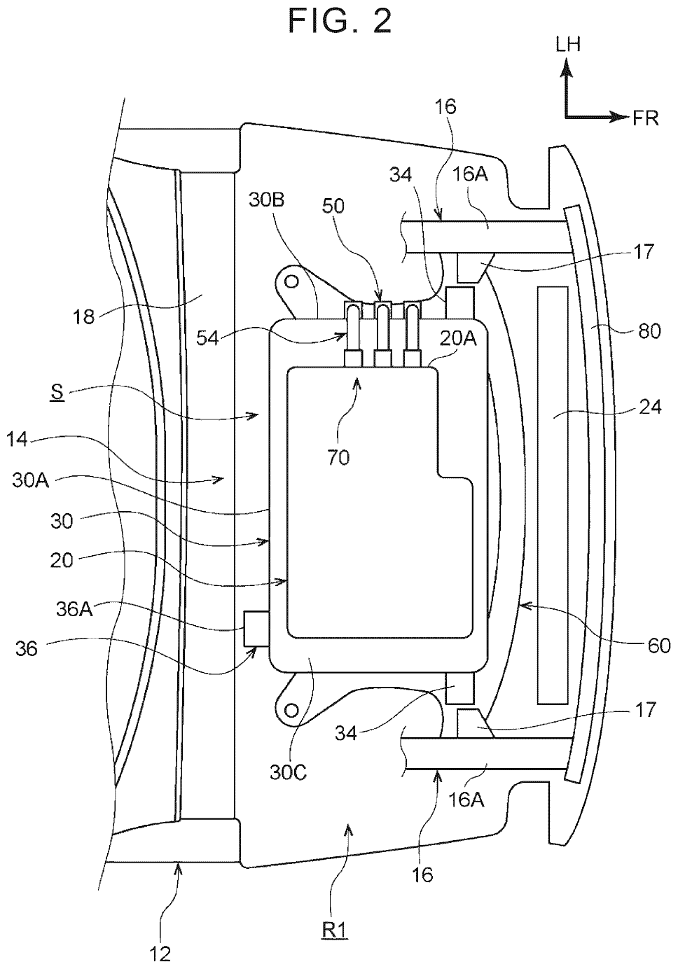

As illustrated in FIG. 2, side members 16, a suspension member 60, a bumper reinforcement 80, and the like are provided at a front portion of the vehicle 12 as a skeleton portion of the vehicle 12.

The side member 16 is a skeleton portion extending along the vehicle front-rear direction on the vehicle width direction outer side of the vehicle front portion, and is provided in a pair of left and right sides. In the power unit room R1, a power unit 14 is disposed between a pair of side members 16. In the power unit room R1, a radiator 24 (see FIG. 2) is disposed on the front side (the front end in the power unit room R1) of the power unit 14 (the transaxle 22 and the inverter 20).

As an example, the power unit 14 is disposed on the vehicle upper side of the suspension member 60, and is supported from the lower side by the suspension member 60. The suspension member 60 is formed in a substantially rectangular frame shape in a plan view, and is disposed on the vehicle lower side of the pair of side members 16. The front end portion and the rear end portion of the suspension member 60 are attached from the lower side to the lower surfaces of the left and right side members 16 at the end portion on the outer side in the vehicle width direction.

In the lower portion of the power unit 14 (the lower portion of the transaxle 22), one portion and the other portion in the vehicle width direction are supported by the suspension member 60 via the mount portion 34 (see FIG. 2).

An end portion of the pair of side members 16 on the vehicle front side is connected to a bumper reinforcement 80 extending in the vehicle width direction. An end portion of the pair of side members 16 on the front side of the vehicle is a so-called crushable zone 16A, and is formed to be more fragile than other portions. The crushable zone 16A is subjected to an axial compressive load equal to or greater than a predetermined value along the front-rear direction of the vehicle, and is subjected to compressive plastic deformation to absorb the impact load. After that, the side member 16 is buckled with the crushable zone 16A as a buckling portion, and the portion on the vehicle front side is buckled inward in the vehicle widthwise direction.

In the present embodiment, the side member 16 has a spacer portion 17 extending from the crushable zone 16A (buckling portion) to the vehicle-width-direction inner side. The spacer portion 17 may be formed integrally with the side member 16, or may be formed of a bracket or the like formed separately from the side member 16. The spacer portion 17 is disposed so as to face the mount portion 34 provided in the power unit 14 in the vehicle width direction. Therefore, when the crushable zone 16A of the side member 16 is buckled by the collision load at the time of the front collision of the vehicle, the spacer portion 17 moves inward in the vehicle widthwise direction and comes into contact with the mount portion 34. Accordingly, the collision load input to the front portion of the vehicle 12 is transmitted to the power unit 14 via the side member 16, the spacer portion 17, and the mount portion 34.

In the power unit room R1, the power unit 14 is disposed to face the dash panel 18 that separates the power unit room R1 and the vehicle cabin. Note that the dash panel 18 is an example of a “vehicle cabin partition wall” of the present disclosure.

The dash panel 18 constitutes a part of the vehicle body as a rear wall portion of the power unit room R1. The dash panel 18 is disposed to face the rear side surface portion 30A of the power unit 14 (the power unit case 30). A protruding portion 36 provided close to the dash panel 18 is formed on the rear side surface portion 30A of the rear side of the power unit 14. As will be described later, the collision load input to the power unit 14 is transmitted to the dash panel 18 via the protruding portion 36.

### Power Unit

Next, a detailed structure of the power unit 14 will be described. As described above, the power unit 14 includes the transaxle 22 that generates power during traveling and the inverter 20 provided at the upper portion of the transaxle 22 (see FIG. 2).

### Transaxle

As illustrated in FIG. 3, the transaxle 22 includes a motor 26 as a drive source, a gear portion 28 that transmits the rotation of the motor 26 to the drive wheels, and a power unit case 30 that houses the motor 26 and the gear portion 28.

### Motor

The motor 26 is, for example, a three-phase AC motor. The motor 26 includes an output shaft 26A arranged in an attitude in which the vehicle-width direction is an axial direction, a rotor (not shown) provided with permanent magnets around the output shaft 26A, and a stator (not shown) formed of a plurality of coils arranged on the outer periphery of the rotor. An AC power having a phase difference is supplied from the inverter to each of the plurality of coils of the stator. This electric power is supplied to the output shaft 26A (rotor) to rotate.

Further, in the motor 26, the wire portion 26B extends from the outer surface on the left side in the vehicle width direction (one side in the vehicle width direction), and is electrically connected to the energization portion 50 (see FIG. 2) provided on the left side surface portion 30B (one side in the vehicle width direction) of the power unit case 30. The wire portion 26B is connected to the respective coils corresponding to the respective phases (U-phase, V-phase, and W-phase) of the three-phase AC motor.

The gear portion 28 is a reduction gear disposed between the output shaft 26A of the motor 26 and a drive shaft (not shown) connected to drive wheels (not shown) of the vehicle 12, and appropriately reduces the rotation of the motor 26 and transmits the rotation to the drive wheels (drive shaft) of the vehicle 12.

### Power Unit Case

The power unit case 30 constitutes an outer shell of the transaxle 22, and is, for example, a metal housing having a substantially cylindrical shape in which the vehicle width direction is an axial direction. In addition, a partition wall portion 31 that partitions an axial intermediate portion in the vehicle width direction is provided inside the power unit case 30. The partition wall portion 31 is provided to partition the accommodation space of the motor 26 and the accommodation space of the gear portion 28 in the power unit case 30.

In the present embodiment, the motor 26 is accommodated in the left side in the vehicle width direction in the power unit case 30, and the gear portion 28 is accommodated in the right side in the vehicle width direction in the power unit case 30. Further, an output shaft 26A of the motor 26 and a drive shaft (not shown) are provided in the partition wall portion 31 in the power unit case 30 so as to penetrate therethrough. As a result, the output shaft 26A of the motor 26 and the intermediate portion of the drive shaft are supported by the partition wall portion 31.

On the left side surface portion 30B constituting the wall portion on the left side in the vehicle width direction (one side in the vehicle width direction) of the power unit case 30, the energization portion 50 is provided at a portion on the vehicle upper side (see FIG. 2). Note that the energization portion 50 may be provided on the upper surface of the left end of the power unit case 30 in the vehicle width direction from the viewpoint of reducing the distance between the energization portion 70 provided in the inverter 20 to be described later. Note that the energization portion 50 is intended to be a conductive portion intended to be energized during normal use, and a specific configuration is not particularly limited, but here is a connector to which one end of the high-voltage harness 54 is connected.

Here, at least one protruding portion 36 is provided in an area facing the dash panel 18 on the rear side surface portion 30A of the power unit case 30, which constitutes a wall portion on the vehicle rear side (vehicle front-rear direction inner side). As an example, the protruding portion 36 is formed of a solid block body formed in a substantially cylindrical shape. The protruding portion 36 may be formed integrally with the power unit case 30 or may be formed separately. Further, the shape is not limited to a cylindrical shape. The protrusion may be hollow. Note that, from the viewpoint of stabilizing a transmission path of a collision load, which will be described later, the protruding portion 36 preferably has a flat surface on a surface 36A facing the dash panel 18, as in the present embodiment.

In the present embodiment, the protruding portion 36 is provided at a portion of the rear side surface portion 30A on the right side in the vehicle width direction (the other side in the vehicle width direction) in the area facing the dash panel 18. As a result, the rear side surface portion (the rear side surface portion 30A of the power unit case 30) of the power unit 14 is provided such that, in a region facing the dash panel 18, a portion on the right side in the vehicle width direction is closer to the dash panel 18 by the height of the protruding portion 36 than a portion on the left side in the vehicle width direction.

Note that the protruding portion 36 may be provided at a portion on the left side in the vehicle width direction (one side in the vehicle width direction) of the rear side surface portion 30A. In this case, the height of the protruding portion 36 provided on the left side in the vehicle width direction (the length in the vehicle front-rear direction) may be set lower than the height of the protruding portion 36 provided on the right side in the vehicle width direction.

### Inverter

The inverter 20 is disposed on the upper side of the transaxle 22 and is integrated with the transaxle 22 via a support member (not shown). The inverter 20 is formed in, for example, a substantially rectangular box shape having a small thickness (a low height) in the vehicle vertical direction (see FIG. 2). The inverter 20 has a longitudinal direction along the vehicle width direction, and is fixed to a substantially central portion of a side surface portion (upper side surface portion 30C of the power unit case 30) on the vehicle upper side of the transaxle 22 via a support member (not shown). In addition, the inverter 20 is provided with the energization portion 70 on the left side surface part 20A disposed facing the left side in the vehicle width direction (one side in the vehicle width direction). The energization portion 70 is intended to be a conductive portion intended to be energized during normal use, and a specific configuration is not particularly limited, but is a connector to which the high-voltage harness 54 is connected. The tip of the high-voltage harness 54 is connected to an energization portion 50 provided on the upper side surface portion 30C of the power unit case 30. As a result, the motor 26 and the inverter 20 are electrically connected to each other via the energization portions 50 and 70 and the high-voltage harness 54.

### Action and Effect

As described above, in the power unit mounting structure 10 according to the present embodiment, the energization portion 50 is provided on the left side surface portion 30B (one side surface part in the vehicle-width-direction) of the transaxle 22 constituting the power unit 14. That is, since the energization portion 50 is not disposed in the vehicle front-rear direction, the energization portion 50 is less susceptible to the impact load at the time of a front collision or a rear collision. As a result, as shown in FIG. 2, the space required to protect the energization portion 50 in the front-rear direction can be reduced, and the dead space S in the power unit room R1 can be suppressed. Here, the dead space S is a dead space in the vehicle front-rear direction generated between the power unit 14 and the dash panel 18.

Further, in the power unit room R1, a dash panel 18 is disposed so as to face a rear side surface portion 30A (a side surface portion inside the vehicle front-rear direction) of the power unit 14. In a region facing the dash panel 18, the power unit 14 is provided such that a portion on the right side in the vehicle width direction (the other side in the vehicle width direction) is closer to the dash panel 18 than a portion on the left side in the vehicle width direction (the one side in the vehicle width direction).

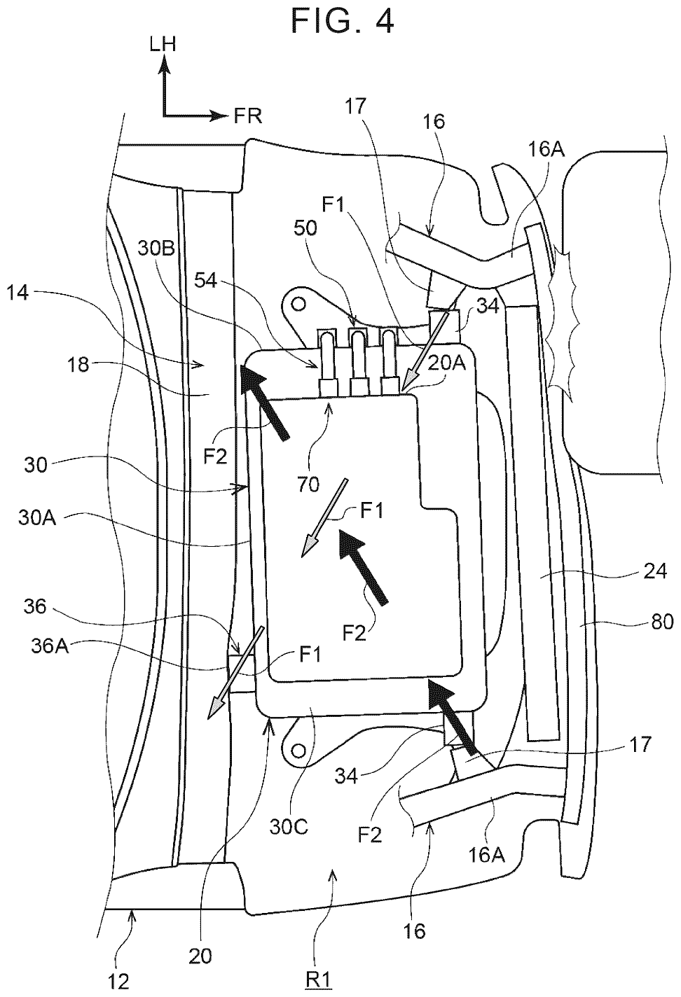

Incidentally, at the time of a front collision or a rear collision of a vehicle, a collision load from the vehicle front-rear direction outer side is inputted into the power unit room R1, and the power unit 14 is moved to the vehicle front-rear direction inner side. For example, in the power unit mounting structure 10 according to the present embodiment, the collision load from the front side of the vehicle is input at the time of the front collision of the vehicle, and the power unit 14 is moved to the rear side of the vehicle (see FIG. 4). Therefore, in the rear side surface portion 30A of the power unit 14, the portion on the right side in the vehicle width direction comes into contact with the dash panel 18 before the portion on the left side in the vehicle width direction.

Here, a portion of the power unit 14 on the left side in the vehicle width direction (one side in the vehicle width direction), that is, a collision load F1 (see FIG. 4) inputted from the outer side in the vehicle front-rear direction to a portion in the vicinity of the energization portion 50 will be considered. The collision load F1 is inputted while the left portion in the vehicle width direction, such as the bumper reinforcement 80 and the side member 16, is buckled inward and rearward in the vehicle width direction. Therefore, the collision load F1 is transmitted from the portion of the power unit 14 on the left side in the vehicle width direction (one side in the vehicle width direction) toward the vehicle rear side (the inner side in the vehicle front-rear direction) and the right side in the vehicle width direction (the other side in the vehicle width direction). Accordingly, the collision load F1 inputted to the portion of the power unit 14 on the left side in the vehicle width direction (one side in the vehicle width direction), that is, the portion near the energization portion 50 is transmitted to the dash panel 18 via the portion of the power unit 14 on the right side in the vehicle width direction (the other side in the vehicle width direction).

As described above, in the present embodiment, by dispersing the collision load F1 inputted in the vicinity of the energization portion 50 toward the vehicle body, it is possible to suppress the damage of the energization portion 50. In this structure, in a region where the power unit 14 faces the dash panel 18, it is not necessary to provide both the portion on the left side in the vehicle width direction (one side in the vehicle width direction) and the portion on the right side in the vehicle width direction (the other side) close to the dash panel 18. In addition, the energization portion 50 is provided in a part of the power unit 14 that is different from the area facing the dash panel 18. Therefore, since the number of structures provided for bringing the power unit 14 and the dash panel 18 close to each other can be reduced and miniaturized, the weight of the power unit 14 can be reduced.

Further, in the present embodiment, the collision load F1 inputted in the vicinity of the energization portion 50 is transmitted to the dash panel 18 via the protruding portion 36 formed in the power unit. In this way, the transmission path of the load can be stabilized by transmitting the collision load F1 through the protruding portion 36. Further, since the shape and the like of the protruding portion 36 can be easily changed, it is possible to perform optimization according to the vehicle type without changing the structure of the main portion of the power unit 14.

Further, in the present embodiment, the motor 26 electrically connected to the energization portion 50 is accommodated in the left side in the vehicle width direction (one side in the vehicle width direction) in the power unit case 30. On the other hand, the gear portion 28 that transmits the rotation of the motor 26 to the drive wheels is accommodated in the right side in the vehicle width direction (the other side in the vehicle width direction) in the power unit case 30. When a collision load F2 (see FIG. 4) is input to the vehicle-width-direction right-side portion of the power unit 14, that is, a collision load F2 is input to a portion away from the energization portion 50 in some cases. In this case, the collision load F2 can be received by the gear portion 28 having a higher bearing capacity than the motor 26. Accordingly, even when the collision load F2 is inputted to the right side of the power unit 14 in the vehicle-width-direction, damage to the energization portion 50 can be suppressed.

Further, in the present embodiment, in the power unit case 30, the accommodation space of the motor 26 and the accommodation space of the gear portion 28 are partitioned by the partition wall portion 31. For this reason, for example, even when the collision load F2 is inputted to a portion of the power unit 14 on the right side in the vehicle width direction (the other side in the vehicle width direction) and the gear portion 28 is damaged, the damage of the gear portion 28 hardly affects the energization portion 50. As a result, it is possible to effectively suppress damage to the energization portion 50.

Although the power unit mounting structure 10 according to the present embodiment has been described above, the power unit mounting structure according to the present disclosure is not limited to the illustrated one, and can be appropriately changed in design without departing from the gist of the present disclosure.

For example, in the above-described embodiment, the power unit mounting structure 10 is configured to be applied to the front portion of the vehicle, but may be applied to the rear portion of the vehicle. In this case, the “vehicle width direction outer side” in the present disclosure is the vehicle rear side, and the “vehicle width direction inner side” corresponds to the vehicle front side.

Further, in the present embodiment, the protruding portion 36 is provided on the side surface portion of the power unit 14 on the inner side in the vehicle front-rear direction, but the present disclosure is not limited thereto. For example, a stepped portion or a rib may be provided at the other portion of the side surface portion of the power unit case on the vehicle front-rear direction inner side in the vehicle width direction. Even in this case, the power unit 14 has a configuration in which, in a region facing the vehicle cabin partition wall, the other portion in the vehicle width direction is provided closer to the vehicle cabin partition wall than the one portion in the vehicle width direction.

In the above-described embodiment, the power unit mounting structure 10 is applied to a battery electric vehicle (EV vehicle), but the present disclosure is not limited thereto. The power unit mounting structure 10 may be applied to PHEV vehicles. In this case, the transaxle as the power unit may be arranged side by side in the vehicle width direction with respect to the engine in a plan view.

What is claimed is:

1. A power unit mounting structure comprising:
a power unit mounted in a power unit room of a vehicle and disposed to face, in a vehicle front-rear direction, a vehicle cabin partition wall that separates the power unit room and a vehicle cabin; and
an energization portion provided on one side surface of the power unit in a vehicle width direction, wherein the power unit is provided, on a side surface facing the vehicle cabin partition wall, closer to the vehicle cabin partition wall at another portion in the vehicle width direction than one portion in the vehicle width direction.

2. The power unit mounting structure according to claim 1, wherein the power unit includes a protruding portion provided at least at the other portion in the vehicle width direction in a region facing the vehicle cabin partition wall, and the protruding portion protrudes inward in the vehicle front-rear direction beyond the one portion in the vehicle width direction.

3. The power unit mounting structure according to claim 1, wherein:
the power unit includes:
a motor electrically connected to the energization portion;
a gear portion configured to transmit rotation of the motor to a drive wheel; and
a power unit case that houses the motor and the gear portion;
the motor is housed on one side in the vehicle width direction in the power unit case; and
the gear portion is housed on another side in the vehicle width direction in the power unit case.

4. The power unit mounting structure according to claim 3, wherein the power unit case includes a partition wall that separates a housing space for the motor and a housing space for the gear portion.
